(19) United States
(12) Patent Application Publication
(10) Pub. No.: US 2006/0111136 A1
(43) Pub. Date: May 25, 2006

(54) Call redirection in a mobile station

(75) Inventor: Kyung-Soo Song, Seoul (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5554, US

(73) Assignee: LG Electronics Inc.

(21) Appl. No.: 11/288,808

(22) Filed: Nov. 28, 2005

(30) Foreign Application Priority Data
Nov. 23, 2004 (KR) 96512/2004

(51) Int. Cl. H04B 7/00; H04Q 7/20

(52) U.S. Cl. 455/519; 455/518; 455/41.2

(57) ABSTRACT

A method for redirecting a wireless communication between mobile stations comprises performing the wireless communication at a first mobile station, and transmitting mobile station information related to the first mobile station from the first mobile station to a second mobile station. The method also comprises receiving the wireless communication at the second mobile station in response to receiving the mobile station information related to the first mobile station, the wireless communication directed to the first mobile station. The method may further comprise determining a battery power level in the first mobile station, and transmitting the mobile station information related to the first mobile station from the first mobile station to the second mobile station if the battery power level is less than a threshold battery power level.

### FIELD OF THE INVENTION

The present invention relates generally to mobile station and, more particularly, to call redirection in a mobile station.

### BACKGROUND OF THE INVENTION

As mobile stations provide additional functionality, such as MP3 player and camera functionality, more power is required by the mobile station, making battery power consumption a more critical factor. Therefore, a high capacity battery has been developed that allows mobile stations to be used for longer time periods. Furthermore, various power saving techniques are being developed to further lengthen the battery usage time by reducing the amount of power consumed.

However, even if battery usage time is increased, mobile station usage is also problematic because when the battery is completely discharged, the user cannot continue to perform voice calls or data communications. This is especially problematic when urgent calls or data must be communicated.

### SUMMARY OF THE INVENTION

Accordingly, the present invention is directed to call redirection in a mobile station that substantially obviates one or more problems due to limitations and disadvantages of the related art.

An object of the present invention is to provide a mobile station and operation thereof whereby information associated with a first mobile station is provided to a second mobile station, such that the user may continue to make and/or receive voice calls and perform data communications through the second mobile station when the first mobile station is in a power-off state.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, in one embodiment, a method for redirecting a wireless communication between mobile stations comprises performing the wireless communication at a first mobile station, and transmitting mobile station information related to the first mobile station from the first mobile station to a second mobile station. The method also comprises receiving the wireless communication at the second mobile station in response to receiving the mobile station information related to the first mobile station, the wireless communication directed to the first mobile station.

The method may further comprise determining a battery power level in the first mobile station, and transmitting the mobile station information related to the first mobile station from the first mobile station to the second mobile station if the battery power level is less than a threshold battery power level. Alternatively, the transmitting of the mobile station information related to the first mobile station from the first mobile station to the second mobile station may be performed if a signal associated with the wireless communication is weak. The wireless communication may comprise at least one of a voice call and a data communication. The method may further comprise, registering, in the second mobile station, the mobile station information related to the first mobile station, and performing the wireless communication at the second mobile station in response to registered mobile station information related to the first mobile station. The mobile station information related to the first mobile station may comprise at least one of an electronic serial number (ESN), an international mobile subscriber identity (IMSI), and a mobile station identification number (MIN).

In another embodiment, a mobile station adapted for redirection of a wireless communication comprises a memory adapted to store mobile station information related to the mobile station. The mobile station also comprises a communication module adapted to transmit the mobile station information related to the mobile station stored in the memory to another mobile station, wherein the mobile station information related to the mobile station is used to perform the wireless communication at the another mobile station. The mobile station also comprises a processor, operatively coupled to the memory and the communication module, adapted to control the memory and the communication module.

The processor may comprise a power sensing unit adapted to sense whether remaining battery power in the mobile station is less than a threshold power level. The power sensing unit may be further adapted to indicate a battery power shortage when the remaining battery power in the mobile station is less than the threshold power level. The processor may further comprise an input and output controller adapted to display a menu to enable a user to transmit the mobile station information related to the mobile station to the another mobile station when a battery power shortage is indicated by the power sensing unit. The processor may further comprise a main controller adapted to transmit the mobile station information related to the mobile station to the another mobile station via the communication module. The communication module may comprise at least one of an infrared transmission device or a Bluetooth® transmission device. The mobile station may further comprise an input unit adapted to receive a user selection signal that indicates whether to transmit the mobile station information related to the mobile station to the another mobile station. The mobile station may further comprise a display unit adapted to display an announcement message when the power sensing unit indicates a battery power shortage. The communication module may be further adapted to receive mobile station information related to the another mobile station to enable a wireless communication directed to the another mobile station to be performed at the mobile station.

In yet another embodiment, a method for operating a mobile station comprises, receiving, in a first mobile station, mobile station information related to a second mobile station. The method also comprises registering, in the first mobile station, received mobile station information related to the second mobile station. The method also comprises performing, in the first mobile station, a wireless communication based on the registered mobile station information related to the second mobile station. The method may further comprise deleting, in the first mobile station, the mobile station information related to the second mobile station after expiration of a set time period.

The foregoing and other objects, features, aspects and advantages of the present invention will become more apparent from the following detailed description of the present invention when taken in conjunction with the accompanying drawings. It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principles of the invention.

FIG. 1 is a schematic block diagram illustrating an exemplary construction of a mobile station, according to an embodiment of the present invention.

FIG. 2 is a flow diagram illustrating a method for operation of a mobile station, according to an embodiment of the present invention.

FIG. 3 is a schematic diagram illustrating a first mobile station being used to perform a voice call and/or data communication using a second mobile station, according to an embodiment of the present invention.

FIG. 4 is a schematic diagram illustrating an exemplary communication procedure between the first and second mobile stations of FIG. 3, according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

The term ‘mobile station’ encompasses mobile phones, handsets, PDAs (personal digital assistants), and computers, as well as any other devices with wireless communication capabilities. Redirecting (e.g., forwarding) calls and/or data from one mobile station to another mobile station is described herein. Such call or data redirecting may be performed from one contact number (e.g., a first phone number) to another contact number (e.g., a second phone number).

The present invention may enable a user of a first mobile station to transmit information related to the first mobile station (e.g., mobile station information) to a second mobile station when the first mobile station is about to be turned off due to lack of battery power, thereby enabling the user to send and receive voice calls and/or perform data communications via the second mobile station, even after the first mobile station has turned off.

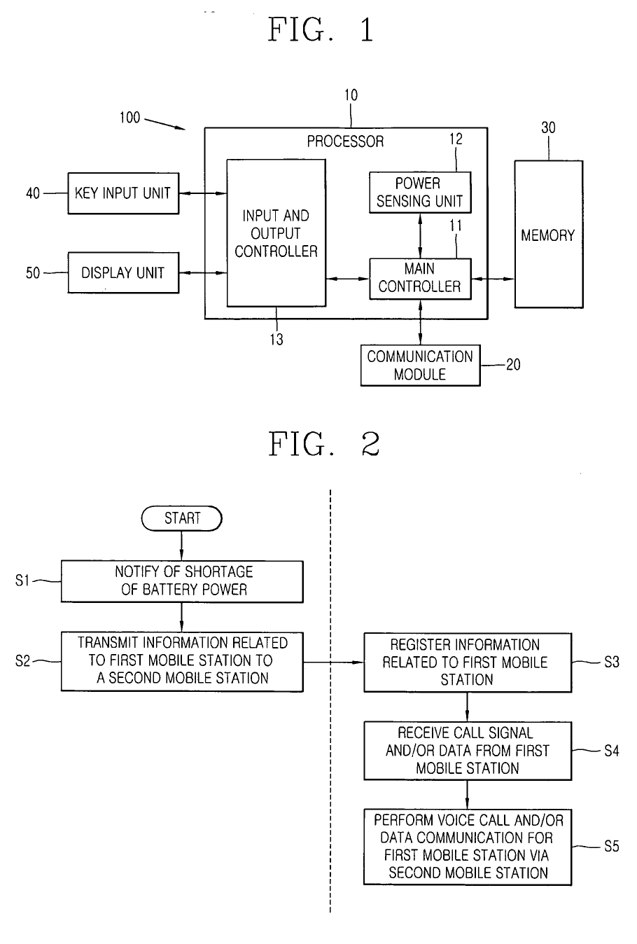

FIG. 1 is a schematic block diagram illustrating an exemplary construction of a mobile station 100, according to an embodiment of the present invention.

Referring to FIG. 1, the mobile station 100 includes a memory 30 for storing information related to a voice call and/or a data communication. The mobile station 100 also includes a communication module 20 for transmitting a call signal, data, and information related to a voice call and/or a data communication through a mobile communication network (e.g., a wireless network). Alternatively, the mobile station 100 may receive a call signal, data, and information related to the voice call and/or the data communication. The mobile station 100 also includes a processor 10 for transmitting the information related to the voice call and/or the data communication through the mobile communication module 20 when a remaining battery power in the mobile station is less than a pre-set power reference value. The mobile station 100 also may include a key input unit 40 for receiving a selection signal from a user indicating whether to transmit the information related to the voice call and/or the data communication externally. The mobile station 100 also includes a display unit 50 for outputting a corresponding announcement message when the remaining battery power in the mobile station is less than the pre-set power reference value.

The memory 30 may store a driving program (e.g., software) for operating the mobile station. The memory 30 may also store data regarding the settings for mobile communications or an address list received from the user. The memory 30 may also store mobile station information (e.g., information related to the mobile station).

The mobile station information may include identifier(s) used to distinguish the mobile station from other mobile stations. For example, each mobile station may have its own unique identifier that distinguishes the mobile station from other mobile stations. The mobile station information thus may include an electronic serial number (ESN), an international mobile subscriber identity (IMSI), and/or a mobile station identification number (MIN) or any other type of identifier.

Based on the mobile station information, the mobile station may perform voice calls or data communications, and the target (e.g., destination) and source (e.g., origin) of the voice call signals and data communications may be checked. Furthermore, by using the mobile station information for a voice call and/or a data communication, the mobile station may allow voice calls and/or data communications to be redirected to another mobile station. The memory 30 may store mobile station information related to its own mobile station, and/or mobile station information related to another mobile station.

The mobile communication module 20 may perform voice calls and/or data communications between mobile stations by transmitting or receiving data through a communication network (e.g., a cellular network, a wireless LAN, etc.). While performing the communication, if the remaining battery power in the mobile station is less than a power threshold value (e.g., a pre-set power reference value), the communication module 20 may transmit the stored mobile station information for the first mobile station to the second mobile station based on a control command of the processor 10. The pre-set power reference value may be based on remaining battery capacity. For example, the pre-set power reference value may be reached when 10% of battery power remains.

Furthermore, the communication module 20 may receive mobile station information from another (e.g., second) mobile station. The received mobile station information is then registered by the processor 10, and the communication module 20 performs a voice call and/or data communication based on the mobile station information. Thus, the mobile station may receive signals based on the mobile station information of the second mobile station for a voice call and/or data communication, as well as signals based on the first mobile station's own information.

The communication module 20 may include a wireless communication device that uses infrared signaling (e.g., IRDA) or Bluetooth® technology, for example, to transmit or receive the mobile station information to or from the second mobile station. Other types of wireless signaling may also be used, such as Voice over Internet Protocol (VoIP) access technologies, for example.

Additionally, to address user privacy and security issues, various procedures for authorization and/or authentication may be performed when communicating the mobile station information between mobile stations. For example, the mobile station information may be encrypted, and/or the mobile stations may use encryption keys and/or security protocols to ensure that only authorized use is permitted.

The processor 10 may include a power sensing unit 12 for sensing the remaining battery power, and for indicating a battery power shortage when the sensed remaining battery power is less than the pre-set power reference value. The processor 10 may also include an input and output controller 13 for displaying a menu used for determining whether to transmit the mobile station information stored in the memory 30 when the power sensing unit 12 indicates that there is a battery power shortage. The processor 10 may also include a main controller 11 used for communicating the mobile station information stored in the memory 30 through the communication module 20.

While the mobile station is driven or operated, the power sensing unit 12 senses the remaining battery power, and if the sensed remaining battery power is less than the pre-set power reference value, the power sensing unit 12 transmits the corresponding information to the main controller 11 to inform the user of the battery power shortage. When there is a battery power shortage, the input and output controller 13 may display an announcement message through the display unit 50 according to a control command of the main controller 11. A menu for communicating the mobile station information may also be displayed. Battery power level indication may be provided to the user in various ways, such as visually (e.g., via the display screen or LED indicators), audibly (e.g., via a speaker or audio device), and/or in a tactile manner (e.g., a vibration mode), for example. Furthermore, in addition to insufficient battery power, other situations may require the mobile station information to be communicated to the second mobile station, such as when the mobile station is “out of range”, or when signal strength is low, for example.

The input and output controller 13 may receive a selection signal from the user through the key input unit 40 regarding whether to transmit the mobile station information to the other mobile station. The input and output controller 13 may also set a signal regarding transmission of the mobile station and transfer the received signals to the main controller 11. The main controller 11 may then transmit the mobile station information to the second mobile station based on the signals inputted from the key input unit 40 and the input and output controller 13, such that the user may perform a voice call and/or data communication through the second mobile station based on the mobile station information provided from the first mobile station to the second mobile station. The key input unit 40 may be used to receive user authentication regarding whether the mobile station information should be sent to the second mobile station. Other types of input devices, such as voice input devices and/or pen-based input devices, for example, may be used instead of the key input unit 40.

Furthermore, when the mobile station information from the second mobile station is received, the main controller 11 stores the mobile station information in the memory 30. The mobile station information is then registered. The main controller 11 then performs a voice call and/or a data communication through the communication module 20 based on the registered specific information.

The main controller 11 may delete the received mobile station information for the second mobile station from the memory 20 so that the mobile station is not continually able to perform voice calls and/or data communications based on the mobile station information of the second mobile station. Such a deletion may be performed after each successful transmission or reception of signals or data. Alternatively, the deletion may be performed periodically, or at a specific point in time. The deletion may help address privacy and security concerns related to sending and receiving the mobile station information between the mobile stations.

The operation of the mobile station 100 is described in detail below with reference to FIGS. 1 to 4.

FIG. 2 is a flow diagram illustrating a method for operation of a mobile station, according to an embodiment of the present invention.

Referring to FIG. 2, the method includes warning of a battery power shortage when the remaining battery power is less than a pre-set power reference value (S1). The method also includes transmitting mobile station information related to a first mobile station to a second mobile station, such as via wireless communication (S2). The method also includes performing a voice call and/or a data communication using the second mobile station based on the mobile station information related to the first mobile station (S5).

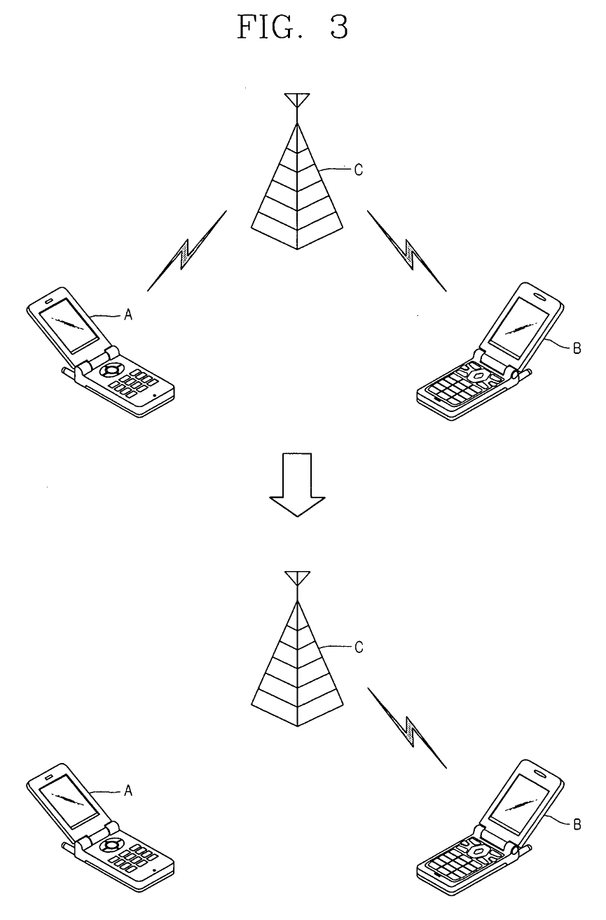

FIG. 3 is a schematic diagram illustrating a first mobile station being used to perform a voice call and/or data communication using a second mobile station, according to an embodiment of the present invention.

Referring to FIGS. 1-3, while a first mobile station A is in a power-on state, the power sensing unit 12 senses the remaining battery power in the first mobile station A. If the sensed remaining battery power is less than a pre-set power reference value, the main controller 11 displays a message to indicate the corresponding situation through the display unit 50. The main controller 11 then displays a menu for transmitting the mobile station information on the display unit 50 (S1).

The user of the first mobile station A may then check the menu for transmitting the mobile station information, and determine whether to transmit the mobile station information to the second mobile station. The first mobile station A may receive, for example, settings pertaining to the second mobile station B and the type of transmission method to be used.

When the user selects an option to transmit the mobile station information, such as through the key input unit 40, from the first mobile station A to the second mobile station B, the transmission may occur through various communication schemes, such as wireless, infrared, or physical connection by via data cable (e.g., USB cable), for example (S2).

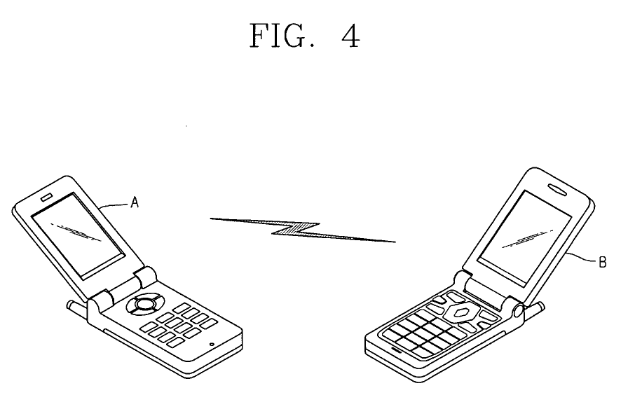

FIG. 4 is a schematic diagram illustrating an exemplary communication procedure between the first and second mobile stations of FIG. 3, according to an embodiment of the present invention.

Referring to FIG. 4, the second mobile station B receives the mobile station information from the first mobile station A, and then stores and registers the mobile station information (S3). After receiving the mobile station information, the second mobile station B senses and receives call signals and/or data communications transmitted to the first mobile station A, as well as call signals and/or data communications transmitted to the second mobile station B (S4). Accordingly, the second mobile station B may perform functions of the first mobile station A, such as voice calls and/or data communications, for example, based on the mobile station information related to the first mobile station A (S5).

It shall be understood that the present invention may be practiced in either direction, that is from the first mobile station to the second mobile station, or from the second mobile station to the first mobile station. Thus, calls and/or data may be handled by the first mobile station for the second mobile station, or by the second mobile station for the first mobile station. Furthermore, it will be understood that the present invention is not limited to two mobile stations, but may be practiced with three or more mobile stations.

A mobile station according to an embodiment of the present invention may include a transceiver to send and receive communication signals, a sensor to sense a battery power level, and a processor cooperating with the transceiver and the sensor to operate in a sending mode or in a receiving mode. In the sending mode, the processor senses when a battery power level is below a threshold power value, sends an identifier to a second mobile station based on the sensing, and allows the second mobile station to perform incoming and outgoing communications intended for the first mobile station. In the receiving mode, the processor receives an identifier from the second mobile station, and performs incoming and outgoing communications intended for the second mobile station.

In one embodiment, a method for redirecting a wireless communication between mobile stations comprises performing the wireless communication at a first mobile station, and transmitting mobile station information related to the first mobile station from the first mobile station to a second mobile station. The method also comprises receiving the wireless communication at the second mobile station in response to receiving the mobile station information related to the first mobile station, the wireless communication directed to the first mobile station.

The method may further comprise determining a battery power level in the first mobile station, and transmitting the mobile station information related to the first mobile station from the first mobile station to the second mobile station if the battery power level is less than a threshold battery power level. Alternatively, the transmitting of the mobile station information related to the first mobile station from the first mobile station to the second mobile station may be performed if a signal associated with the wireless communication is weak. The wireless communication may comprise at least one of a voice call and a data communication. The method may further comprise, registering, in the second mobile station, the mobile station information related to the first mobile station, and performing the wireless communication at the second mobile station in response to registered mobile station information related to the first mobile station. The mobile station information related to the first mobile station may comprise at least one of an electronic serial number (ESN), an international mobile subscriber identity (IMSI), and a mobile station identification number (MIN).

In another embodiment, a mobile station adapted for redirection of a wireless communication comprises a memory adapted to store mobile station information related to the mobile station. The mobile station also comprises a communication module adapted to transmit the mobile station information related to the mobile station stored in the memory to another mobile station, wherein the mobile station information related to the mobile station is used to perform the wireless communication at the another mobile station. The mobile station also comprises a processor, operatively coupled to the memory and the communication module, adapted to control the memory and the communication module.

The processor may comprise a power sensing unit adapted to sense whether remaining battery power in the mobile station is less than a threshold power level. The power sensing unit may be further adapted to indicate a battery power shortage when the remaining battery power in the mobile station is less than the threshold power level. The processor may further comprise an input and output controller adapted to display a menu to enable a user to transmit the mobile station information related to the mobile station to the another mobile station when a battery power shortage is indicated by the power sensing unit. The processor may further comprise a main controller adapted to transmit the mobile station information related to the mobile station to the another mobile station via the communication module. The communication module may comprise at least one of an infrared transmission device or a Bluetooth® transmission device. The mobile station may further comprise an input unit adapted to receive a user selection signal that indicates whether to transmit the mobile station information related to the mobile station to the another mobile station. The mobile station may further comprise a display unit adapted to display an announcement message when the power sensing unit indicates a battery power shortage. The communication module may be further adapted to receive mobile station information related to the another mobile station to enable a wireless communication directed to the another mobile station to be performed at the mobile station.

In yet another embodiment, a method for operating a mobile station comprises, receiving, in a first mobile station, mobile station information related to a second mobile station. The method also comprises registering, in the first mobile station, received mobile station information related to the second mobile station. The method also comprises performing, in the first mobile station, a wireless communication based on the registered mobile station information related to the second mobile station. The method may further comprise deleting, in the first mobile station, the mobile station information related to the second mobile station after expiration of a set time period.

The present invention may enable a voice or data communication to be redirected between mobile stations, such that the communication may be continued even after battery power to the originally communicating terminal is shut off.

It will be apparent to those skilled in the art that various modifications and variations may be made in the present invention without departing from the spirit or scope of the inventions. Thus, it is intended that the present invention covers the modifications and variations of this invention provided they come within the scope of the appended claims and their equivalents.

What is claimed is:

1. A method for redirecting a wireless communication between mobile stations, the method comprising:
performing the wireless communication at a first mobile station;
transmitting mobile station information related to the first mobile station from the first mobile station to a second mobile station; and
receiving the wireless communication at the second mobile station in response to receiving the mobile station information related to the first mobile station, the wireless communication directed to the first mobile station.

2. The method of claim 1, further comprising:
determining a battery power level in the first mobile station; and
transmitting the mobile station information related to the first mobile station from the first mobile station to the second mobile station if the battery power level is less than a threshold battery power level.

3. The method of claim 1, wherein the transmitting the mobile station information related to the first mobile station from the first mobile station to the second mobile station is performed if a signal associated with the wireless communication is weak.

4. The method of claim 1, wherein the wireless communication comprises at least one of a voice call and a data communication.

5. The method of claim 1, further comprising:
registering, in the second mobile station, the mobile station information related to the first mobile station; and
performing the wireless communication at the second mobile station in response to registered mobile station information related to the first mobile station.

6. The method of claim 1, wherein the mobile station information related to the first mobile station comprises at least one of an electronic serial number (ESN), an international mobile subscriber identity (IMSI), and a mobile station identification number (MIN).

7. The method of claim 1, wherein the transmitting of the mobile station information related to the first mobile station from the first mobile station to the second mobile station is performed via one of the group comprising infrared transmission, Bluetooth® transmission, and wired transmission.

8. A mobile station adapted for redirection of a wireless communication, the mobile station comprising:
a memory adapted to store mobile station information related to the mobile station;
a communication module adapted to transmit the mobile station information related to the mobile station stored in the memory to another mobile station, wherein the mobile station information related to the mobile station is used to perform the wireless communication at the another mobile station; and
a processor, operatively coupled to the memory and the communication module, adapted to control the memory and the communication module.

9. The mobile station of claim 8, wherein the processor comprises:
a power sensing unit adapted to sense whether remaining battery power in the mobile station is less than a threshold power level.

10. The mobile station of claim 9, wherein the power sensing unit is further adapted to indicate a battery power shortage when the remaining battery power in the mobile station is less than the threshold power level.

11. The mobile station of claim 10, wherein the processor further comprises:
an input and output controller adapted to display a menu to enable a user to transmit the mobile station information related to the mobile station to the another mobile station when a battery power shortage is indicated by the power sensing unit.

12. The mobile station of claim 11, wherein the processor further comprises:
a main controller adapted to transmit the mobile station information related to the mobile station to the another mobile station via the communication module.

13. The mobile station of claim 8, wherein the communication module comprises at least one of an infrared transmission device or a Bluetooth® transmission device.

14. The mobile station of claim 11, further comprising:
an input unit adapted to receive a user selection signal that indicates whether to transmit the mobile station information related to the mobile station to the another mobile station.

15. The mobile station of claim 10, further comprising:
a display unit adapted to display an announcement message when the power sensing unit indicates a battery power shortage.

16. The mobile station of claim 8, wherein the mobile station information related to the mobile station comprises at least one of an electronic serial number (ESN), an international mobile subscriber identity (IMSI), and a mobile station identification number (MIN).

17. The mobile station of claim 8, wherein the communication module is further adapted to receive mobile station information related to the another mobile station to enable a wireless communication directed to the another mobile station to be performed at the mobile station.

18. A method for operating a mobile station, the method comprising:
receiving, in a first mobile station, mobile station information related to a second mobile station;
registering, in the first mobile station, received mobile station information related to the second mobile station; and
performing, in the first mobile station, a wireless communication based on the registered mobile station information related to the second mobile station.

19. The method of claim 18, further comprising:
deleting, in the first mobile station, the mobile station information related to the second mobile station after expiration of a set time period.

20. The method of claim 18, wherein the wireless communication comprises at least one of a voice call and a data communication.

21. The method of claim 18, wherein the mobile station information related to the second mobile station comprises at least one of an electronic serial number (ESN), an international mobile subscriber identity (IMSI), and a mobile station identification number (MIN).

22. The method of claim 18, wherein the receiving, in the first mobile station, the mobile station information related to the second mobile station is performed via one of the group comprising infrared communication, Bluetooth® communication, and wired communication.
